(19) United States
(12) Patent Application Publication
(10) Pub. No.: US 2008/0086530 A1
(43) Pub. Date: Apr. 10, 2008

(54) SYSTEM AND METHOD FOR RESTRICTING REPLIES TO AN ORIGINAL ELECTRONIC MAIL MESSAGE

(76) Inventors: Rajeev H. Gandhi, Cedar Park, TX (US); Scott L. Winters, Austin, TX (US); Richard A. Zevin, Austin, TX (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/539,770

(22) Filed: Oct. 9, 2006

(51) Int. Cl. G06F 15/16

(52) U.S. Cl. 709/206

(57) ABSTRACT

A system and method for restricting replies to an original electronic mail message are provided. The system and method may provide a mechanism for allowing a composer of an electronic mail message to specify whether or not responses or replies from particular recipients, e.g., secondary recipients, of an electronic mail message are permitted. The illustrative embodiments provide an interface through which a user may specify, for example, that an electronic mail message that is being composed can only be replied to from electronic mail addresses that are associated with primary recipients of the electronic mail message, e.g., recipients whose electronic mail addresses are in a “TO” field of the electronic mail message. In other illustrative embodiments, the interface provides control mechanisms through which a user may individually specify which recipients of an electronic mail message may or may not reply to the electronic mail message.

### BACKGROUND

1. Technical Field

The present application relates generally to an improved data processing system and method. More specifically, the present application is directed to a system and method for restricting replies to an original electronic mail message.

2. Description of Related Art

Typically, when a user composes an electronic mail message, the user specifies one or more primary recipients of the electronic mail message and may specify one or more parties to receive “carbon copies” of the electronic mail message. The primary recipients are typically identified in a “TO” field of the electronic mail message while the optional “carbon copy,” or secondary, recipients are identified in a carbon copy (CC) field or blind carbon copy (BCC) field of the electronic mail message.

The composer of the electronic mail message may intend to send the electronic mail message to the primary parties in order to engage these parties in a discussion or other type of interaction. Thus, the composer may expect and even intend to receive responses or replies to the composed electronic mail message from the primary recipients.

Conversely, the composer of the electronic mail message may intend to send the electronic mail message to the secondary parties only as a courtesy or only for informative reasons. The composer may not intend to enter into a discussion or interaction with the secondary recipients. However, since there currently are no controls in known electronic mail mechanisms for controlling whether or not responses or replies from secondary recipients are received by the composer, the composer may actually receive unwanted responses or replies from the secondary recipients. This may cause the composer to be brought into an unwanted discussion or interaction with a secondary recipient. This can be annoying to the composer of the original electronic mail message and may even cause the composer to not send copies of electronic mail messages to some parties in order to avoid such unwanted responses or replies.

### SUMMARY

The illustrative embodiments provide a mechanism for allowing a composer of an electronic mail message to specify whether or not responses or replies from recipients of an electronic mail message are permitted. The illustrative embodiments provide an interface through which a user may specify, for example, that an electronic mail message that is being composed can only be replied to from electronic mail addresses that are associated with primary recipients of the electronic mail message. For example, the electronic mail message may only be replied to from electronic mail addresses specified in a “TO” field of the electronic mail message. In other illustrative embodiments, the interface provides control mechanisms through which a user may individually specify which recipients of an electronic mail message may respond or reply to the electronic mail message, or which recipients may not respond or reply to the electronic mail message.

The use of the control mechanisms of the illustrative embodiments causes a recipient reply restriction identifier to be added to the electronic mail message data structure. For example, the recipient reply restriction identifier may be added as a “reply-from-to” tag that is added to the code defining the electronic mail message. Thus, the recipient reply restriction identifier is transmitted with the electronic mail message data structure to the various recipients, both primary recipients and secondary recipients if any. The recipient reply restriction identifier may identify those recipients of the electronic mail message that may respond or reply to the electronic mail message. In an alternative embodiment, the recipient reply restriction identifier may identify those recipients of the electronic mail message from which responses or replies are not permitted. In particular, in one illustrative embodiment, individual recipients of the electronic mail message may be designated as being recipients from which responses or replies are not permitted.

At a recipient computing device running an electronic mail client application, the received electronic mail message may be processed and thus, the additional recipient reply restriction identifier may be processed, when representing the electronic mail message via the electronic mail client application. As part of the processing of the recipient reply restriction identifier, the electronic mail message may be displayed with an indicator that responses to the electronic mail message are restricted. Moreover, the electronic mail client application may display warning messages and prevent the sending of responses or replies to an electronic mail message if the recipient that is responding or replying has been designated as a recipient from which responses and replies are not permitted in the recipient reply restriction identifier. In some illustrative embodiments, actual electronic mail client application user interface elements may be disabled or removed from the user interface in response to the recipient attempting to respond or reply to the electronic mail message in order to eliminate the recipient's ability to respond or reply.

In other illustrative embodiments, the designation of the recipients from which responses or replies are not permitted causes the electronic mail client application of the originator of the electronic mail message to add the addresses for those designated recipients to a software filtering mechanism. As a result, if a response or reply is received from a recipient whose address is in the software filtering mechanism for a particular electronic mail message, the response or reply message may be automatically blocked or added to a trash folder. An automated response electronic mail message may be returned to the recipient to indicate that their response/reply was ignored or blocked.

In one illustrative embodiment, a method is provided for specifying recipients of an original electronic mail (email) message that may respond to the original email message. The method may comprise providing a user interface through which the original email message may be composed, receiving a first user input to the user interface specifying one or more email addresses of one or more recipients of the original email message and a content of the original email message, and receiving a second user input selecting a response restriction option to prevent response email messages to the original email message from at least one of the one or more email addresses of the one or more recipients. The method may further comprise adding an indicator of the selected response restriction option to a data structure associated with the original email message and transmitting the original email message to one or more computing devices associated with the one or more email addresses of the one or more recipients.

Receiving a second user input may comprise receiving a selection of one or more individual email addresses of one or more recipients of the original email message whose responses to the original email message are to be restricted. Moreover, receiving a second user input may comprise receiving a selection of a restriction option that specifies that email addresses of all secondary recipients of the original email message are restricted from sending response email messages while email addresses associated with primary recipients of the original email message are permitted to send response email messages. The primary recipients may be recipients whose email address is specified by the first user input in a “TO” field of the user interface. The secondary recipients may be recipients whose email address is specified by the first user input in either a carbon copy field or a blind carbon copy field of the user interface.

Adding an indicator of the selected response restriction option to a data structure associated with the original email message may comprise adding the indicator to data representing the original email message. The indicator may specify one of one or more email addresses of the one or more recipients of the original email message that may send response email messages or one or more email addresses of the one or more recipients of the original email message that may not send response email messages. The indicator may be a markup language tag having corresponding attributes, added to code of the original email message.

The method may further comprise processing the indicator along with remaining data representing the original email message at a recipient computing device associated with a recipient whose email address is specified by the first user input. The method may also comprise determining if the recipient is to be prevented from sending a response to the original email message, wherein the determination is based on the indicator and modifying an email user interface on the recipient's computing device to prevent a response email message to the original email message from being composed if it is determined that the recipient is to be prevented from sending a response to the original email message. Modifying the email user interface on the recipient's computing device may comprise making an option to respond to the original email message unselectable by a user of the recipient's computing device.

The method may further comprise inserting, in response to receiving the second user input, a visual indicator in a representation of the original email message indicating that responses to the original email message are restricted.

Adding an indicator of the selected response restriction option to a data structure associated with the original email message may comprise generating a filter data structure, the filter data structure specifying one of one or more email addresses of the one or more recipients that may send response email messages to the original email message or one or more email addresses of the one or more recipients that may not send response email messages to the original email message. Adding the indicator may further comprise storing the filter data structure on the data processing system in association with an identifier of the original email message.

The method may further comprise receiving a response email message to the original email message and comparing an email address of an originator of the response email message to one or more email addresses specified in the filter data structure to thereby determine if the response email message is to be output on the data processing system. The method may also comprise blocking an output of the response email message on the data processing system if a result of the determination is that the response email message is not to be output on the data processing system.

Blocking the output of the response email message on the data processing system may comprise one of automatically deleting the response email message or automatically placing the response email message in a specified data structure associated with an email application running on the data processing system. The method may further comprise automatically sending, in response to blocking the output of the response email message on the data processing system, a reply email message to the originator of the response email message, the reply email message having content indicating that the response email message has been ignored.

In other illustrative embodiments, a computer program product comprising a computer useable medium having a computer readable program is provided. The computer readable program, when executed on a computing device, causes the computing device to perform various ones, and combinations of, the operations outlined above with regard to the method illustrative embodiment.

In yet another illustrative embodiment, an apparatus is provided. The apparatus may comprise a processor and a memory coupled to the processor. The memory may comprise instructions which, when executed by the processor, cause the processor to perform various ones, and combinations of, the operations outlined above with regard to the method illustrative embodiment.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an exemplary block diagram illustrating a distributed data processing environment in which exemplary aspects of the illustrative embodiments may be implemented;

FIG. 2 is an exemplary block diagram of a data processing device in which exemplary aspects of the illustrative embodiments may be implemented;

FIG. 3 is an exemplary block diagram illustrating an overall methodology in accordance with one illustrative embodiment;

FIG. 4 is an exemplary diagram illustrating a user interface of an electronic mail client application in which an option to receive responses from only those recipients identified in a “TO” field of the electronic mail message is provided in accordance with one illustrative embodiment;

FIG. 5 is an exemplary diagram illustrating a representation of the email of FIG. 4 as it is rendered on a secondary recipient's computing device in accordance with one illustrative embodiment;

FIG. 6 is an exemplary diagram illustrating a user interface of an electronic mail client application in which individual recipients may be specified as recipients from which response may not be received in accordance with one illustrative embodiment;

FIG. 7 is an exemplary diagram illustrating a recipient reply restriction identifier of an electronic mail message in accordance with one illustrative embodiment;

FIG. 8 is a flowchart outlining an exemplary operation of an electronic mail client application when generating an electronic mail message for transmission in accordance with one illustrative embodiment;

FIG. 9 is a flowchart outlining an exemplary operation of an electronic mail client application when receiving an electronic mail message in accordance with one illustrative embodiment; and

FIG. 10 is a flowchart outlining an exemplary operation of a client email application when receiving a reply to an original email in accordance with one illustrative embodiment.

### DETAILED DESCRIPTION OF THE ILLUSTRATIVE EMBODIMENTS

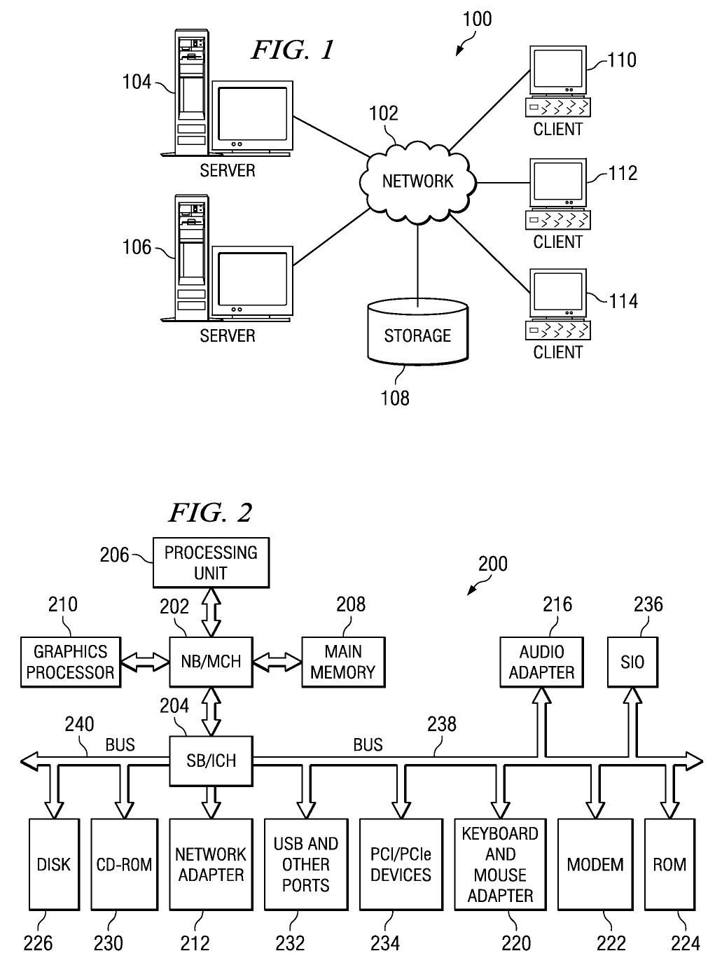

The illustrative embodiments provide a mechanism for controlling which recipients of an electronic mail message may respond to the electronic mail message. As such, the illustrative embodiments are primarily concerned with the operations of data processing devices in a distributed data processing environment, such as a network, a plurality of networks, the Internet, or the like. Thus, in order to provide a context for the description of the illustrative embodiments, FIGS. 1-2 are provided hereafter as examples of a distributed data processing environment and a data processing device in which exemplary aspects of the illustrative embodiments may be implemented. It should be appreciated that FIGS. 1-2 are only exemplary and are not intended to state or imply any limitation with regard to the types of, or configurations of, data processing environments and data processing devices that may be used with the mechanisms of the illustrative embodiments.

With reference now to the figures and in particular with reference to FIGS. 1-2, exemplary diagrams of data processing environments are provided in which illustrative embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of an exemplary distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an exemplary data processing system is shown in which aspects of the illustrative embodiments may be implemented. Data processing system 200 is an example of a computer, such as hosts 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

Referring again to FIG. 1, a user of a client computing device 110 may wish to communicate with a user of another client computing device 112 using electronic mail via an electronic mail server, such as server 104. The user of client device 110 may invoke an electronic mail client application on client device 110 to compose the electronic mail message (hereafter referred to as an email) and specify one or more recipients of the email. As is generally known in the art, such email client applications allow a user to specify one or more primary recipients of the email, such as in a “TO” field of the email client application's user interface, and one or more secondary recipients of the email, such as in the “CC” or “BCC” fields of the email client application's user interface, if desired. However, it is also possible to compose an email with only one or more secondary recipients specified and no primary recipients specified as well.

With the mechanisms of the illustrative embodiments, the email client application is provided with additional functionality, and additional user interface elements, for specifying whether response, or reply, emails are to be disabled for non-primary recipients of the composed email. That is, the composer of the email may decide that he/she does not want to receive responses or replies from users having the email addresses specified in the “CC” or “BCC” fields of the composed email. The illustrative embodiments provide mechanisms for specifying such a desire during the composition of an email and for enforcing such a desire when handling response or reply emails from such secondary recipients.

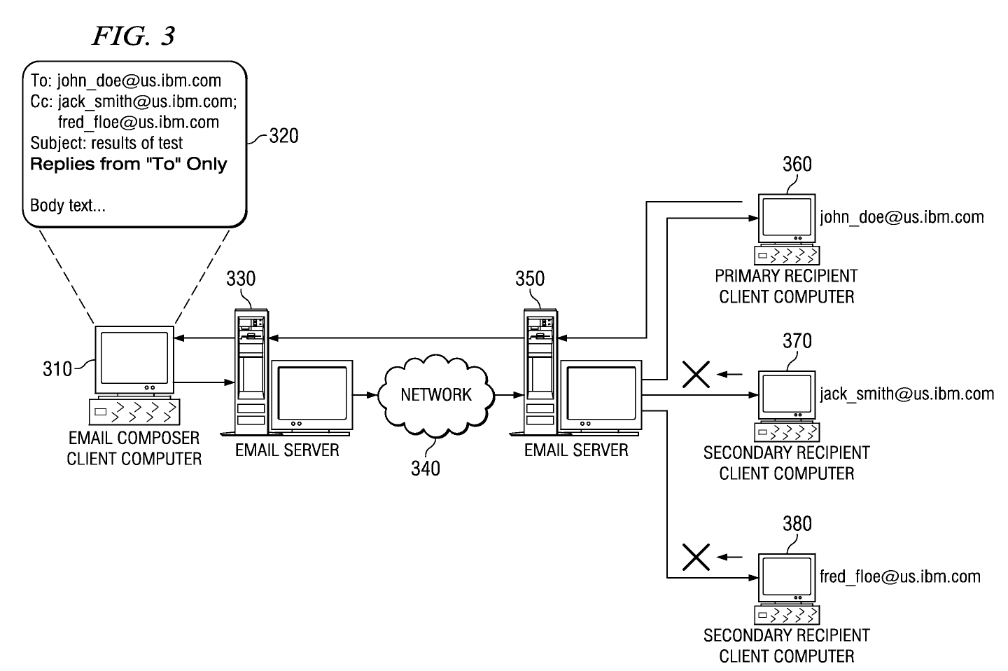

FIG. 3 is an exemplary block diagram illustrating an overall methodology in accordance with one illustrative embodiment. As shown in FIG. 3, a composer of an email may utilize his/her client computing device 310 to compose an email 320 having zero or more primary recipients designated in a “TO” field of the email 320, zero or more secondary recipients in a “CC” or “BCC” field of the email 320, and body text of the email. While it is not required that the email have a primary recipient specified, and zero or more secondary recipients may be specified, at least one recipient of the email must be specified, whether that be a primary or secondary recipient.

In addition, in accordance with the mechanisms of the illustrative embodiments, the composer may specify that responses or replies to this email 310 may only be generated or presented to the user via the client computing device 310 when the response or reply is from an email address corresponding to the primary recipients of the original email 310. The designation of this recipient reply restriction when composing the email 320 may cause an identifier of the recipient reply restriction to be incorporated into the data representation of the email message 320, e.g., as a tag in a header of the email message data representation.

The recipient reply restriction identifier is incorporated into the data representation of the email message 320 and thus, is transmitted along with the email message 320 to the various designated recipient computing devices 360-380. The email message 320 data representation, e.g., data packets, may be transmitted to the recipient computing devices 360-380 via the composer's email server 330, one or more networks 340, and one or more recipient email servers 350. While only one recipient email server 350 is depicted in FIG. 3 as servicing all of the recipient client computing devices 360-380, it should be appreciated that each recipient client computing device 360-380 may have its own email server.

Since the data representation of the email message 320 incorporates the recipient reply restriction identifier, when the email message 320 is processed by the email client applications on the recipient client computing devices 360-380, the recipient reply restriction identifier is also processed by the email client applications, if the email client applications support such recipient reply restriction. Whether or not the email client applications support such recipient reply restrictions, a representation of the email in the email client application user interface includes an identifier, e.g., highlighted or otherwise conspicuously presented text statement, to indicate to the user that the email message 320 is subject to a recipient reply restriction.

In one illustrative embodiment, email client applications on recipient computing devices 360-380 may support processing of the recipient reply restriction identifiers in emails 320 to thereby impose controls over the types of inputs that the user may invoke via the user interface of the email client application with regard to the received email 320. For example, the email client application may recognize the presence of the recipient reply restriction identifier in the email 320 and, as a result, compare a email address associated with the recipient client computing device 360-380 to the email addresses specified in the “TO” field to determine if the recipient client computing device 360-380 is a primary recipient or secondary recipient of the email 320. If the recipient client computing device 360-380 is a primary recipient of the email 320, the email client application may operate in a normal manner as is generally known in the art. If the recipient client computing device 360-380 is a secondary recipient of the email, additional functionality of the email client application is invoked to restrict the user's ability to reply to the original email 320.

Thus, for example, in the depicted example of FIG. 3, the email client application of client computing device 360 may operate in a normal manner since the email address of the user of the client computing device 360 matches an email address specified in the “TO” field of the original email 320, i.e. the user of the client computing device 360 is a primary recipient of the original email 320. For client computing devices 370-380, the email addresses associated with the email client applications of theses computing devices match email addresses in the “CC” field of the original email 320 and thus, are secondary recipients of the email 320. As a result, the additional functionality of the illustrative embodiments for restricting responses or replies from these client computing devices 370-380 is invoked with regard to these client computing devices 370-380.

In one illustrative embodiment, this additional functionality may include determining when a user of the recipient client computing device 360-380 selects an element of the email client application's user interface for replying to the original email 320. In response to the user selecting such an element, the email client application may output, via the recipient client computing device, a message informing the user that replies to the original email 320 are restricted. In this way, users associated with secondary recipient email addresses are informed that they should not attempt to respond or reply to the original email 320. With such an embodiment, the actual reply ability of the client email application is not inhibited. Thus, while the user is informed that the user should not reply to the original email 320, the user may still ignore the warning message and reply anyway.

In other illustrative embodiments, the recipient reply restriction identifier may be used to disable reply elements of the user interface of the email client application. That is, when the original email 320 is represented in the email client application of the recipient client computing device, the user interface elements that allow replies to emails to be disabled, e.g., grayed out or removed from the user interface.

The ability to respond or reply to the original email 310 may be disabled in the user interfaces of the email client applications on the secondary recipient computing devices 340 and 350. Thus, the email client application may forcibly impose the recipient reply restriction on the secondary recipients of the original email 320.

In some illustrative embodiments where recipient reply restrictions are not forcibly enforced, the specifying of the recipient reply restriction may cause a filter data structure to be generated by the email client application used to generate the original email 320. This filter data structure may be keyed to an identifier of the original email 320 such that when a reply to the original email 320 is received, the filter data structure may be applied to the email address of the sender of the reply email. If the email address of the sender is not within the “TO” field of the original email 320, i.e. the sender of the replay email is not a primary recipient of the original email 320, then the reply email may be discarded, placed in a junk mail or trash folder of the email client application, or otherwise not provided to the user of the client device 310 from which the original email 320 was sent. A response email may be sent back to the sender of the reply email to inform the sender that their reply email is being ignored due to the request in the original email 320 that replies only be provided by primary recipients.

In still further illustrative embodiments, rather than specifying that all recipients specified in the secondary recipient fields are restricted from sending replies, the mechanisms of the illustrative embodiments may allow a composer of an original email 320 may specify individual recipients of the original email 320 that are to be restricted from providing replies to the original email 320. Thus, some secondary recipients may be allowed to send replies while others are not.

Thus, with the mechanisms of the illustrative embodiments, replies to emails may be restricted or filtered such that only replies from primary recipients of an original email are received by a composer of the original email. This serves to minimize the amount of unwanted replies the composer of the original email is subjected to. As a result, the composer of the original email is not engaged in unwanted conversations with secondary recipients of an original email when the sending of the original email to the secondary recipients was for informative or courtesy reasons only.

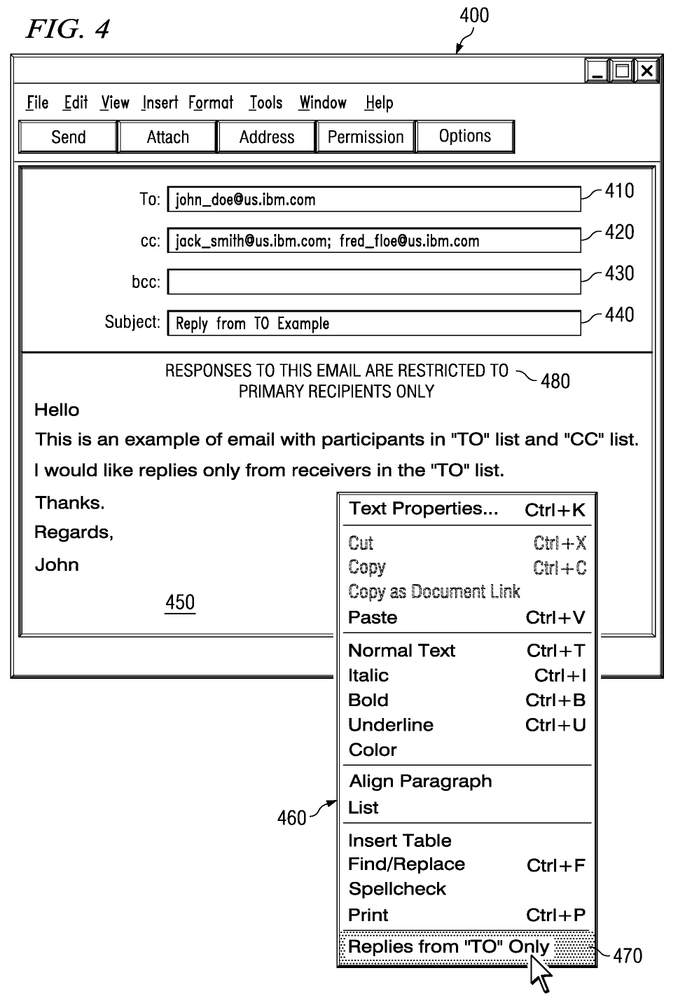

FIG. 4 is an exemplary diagram illustrating a user interface of an electronic mail client application in which an option to receive responses from only those recipients identified in a “TO” field of the electronic mail message is provided in accordance with one illustrative embodiment. As shown in FIG. 4, the user interface 410 includes fields 410-440 for entry of email addresses of primary recipients, email addresses of secondary recipients, and a subject description of the email. For example, a “TO” field 410 is provided for specifying zero or more primary recipients of the email. A carbon copy “CC” field 420 and blind carbon copy “BCC” field 430 are provided for specifying the email addresses of zero or more secondary recipients of the email. If no primary recipient is specified in field 410, at least one recipient should be specified in either field 420 or field 430. If a recipient is specified in field 410, there is no requirement that any other recipients be specified in fields 420 and 430, although it is permissible to set forth additional recipients in these fields.

A field 450 of the user interface 400 is provided for entry of the body text of the email. This body text comprises the actual message of the email. A user may make use of a word processor or other email editor application to compose the body text of the email.

A user may access various options for composing the email including an option to limit responses or replies to the email to only those recipients specified in the “TO” field of the email. For example, a user may “right click” a computer mouse when composing the email using the user interface shown in FIG. 4 to bring up a pop-up menu 460. This pop-up menu 460, along with other possible user selectable options, may include an option 470 for limiting replies to the email to only those recipients specified in the “TO” field 410. As a result, a recipient reply restriction identifier is added to the content of the email. In addition, a visual identifier 480 that replies are restricted may be added to the body text field 450 or another field of the email.

While a pop-up menu 460 is illustrated in FIG. 4, it should be appreciated that the illustrative embodiments are not limited to any particular type of user interface element. Rather, any of a number of different types of user interface elements may be used to facilitate the functionality of the illustrative embodiments including virtual buttons, drop-down menus, pop-up menus, hyperlinks, slider-bars, or any other type of user interface element. Moreover, particular keys, or combination of keys, of a keyboard may be used as a basis for selecting the functionality of the illustrative embodiments. In short, any type of user interface for selecting or otherwise invoking the operation of the illustrative embodiments is intended to be within the spirit and scope of the present invention.

With the user interface 400 a user that is composing an email message may enter email addresses of zero or more primary recipients in field 410, zero or more email addresses of secondary recipients in fields 420 and 430, a subject of the email in field 440, and body text in field 450. The user may then invoke pop-up menu 460 in order to select an option 470 to restrict replies to the present email to only those recipients specified in the “TO” field 410 of the email. As a result, the visual message 480 may be added to the body text in field 450 (or a visual indicator may be provided in some other portion of the email), and a corresponding identifier may be incorporated into the code or data comprising the email. For example, a tag or the like may be added to the code that defines the email, the tag specifying a “reply from TO” option being selected.

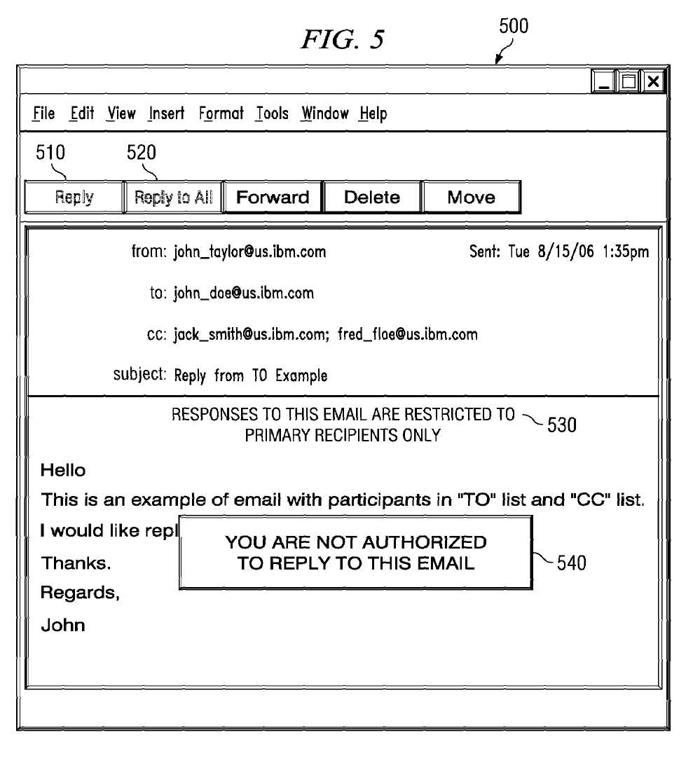

FIG. 5 is an exemplary diagram illustrating a representation of the email of FIG. 4 as it is rendered on a secondary recipient's computing device in accordance with one illustrative embodiment. In the depicted example, when processing the code/data representing the email, the indicator in the code/data of the email specifying a “reply from TO” option being associated with the email is also processed. This processing may cause the email client application at the secondary recipient's computing device to deactivate or otherwise make unselectable, the options 510 and 520 to reply to the email since the “reply from TO” option is enabled and the email address associated with the computing device is a secondary recipient's email address (the non-selectable nature of options 510 and 520 is depicted in FIG. 5 as a different font from the font used for selectable options).

In addition to the mechanism above in which the options 510 and 520 are not selectable, or alternatively, if options 510 and 520 are permitted to remain selectable, a pop-up message 540 may be displayed to a user of the secondary recipient computing device when the user selects one of the options 510 and 520. In such an alternative embodiment, the user may still be allowed to reply to the email message even if the pop-up message 540 is displayed. However, as described above, the pop-up message 540 provides an indicator to the user that they are not supposed to reply to the email and if they do, their replay may be ignored. For example, as described above, the originator of the email may have a filter list associated with the email that is applied to any replies to the email to determine whether the replies are to be presented to the originator of the email or not. If the replies are from secondary recipients, the reply emails may be automatically discarded, placed in a trash or junk mail folder, or the like.

As shown in FIG. 5, at the secondary recipient's computing device, the email composed using the interface of FIG. 4 is rendered with an indicator 530 of the recipient reply restriction being visually represented in association with the email. In the depicted example, the indicator 530 is displayed as a text message as part of the body text of the email, although other ways of representing the indicator 530 may be used without departing from the spirit and scope of the present invention. The indicator 530 may have been added at the originator's computing device, as described with regard to FIG. 4 above, or may be automatically generated at the secondary recipient's computing device in response to processing the “reply from TO” indicator in the code/data of the email.

The above illustrative embodiments assume that all of the recipients specified in the carbon copy “CC” field or blind carbon copy “BCC” field are to be restricted from sending replies to the original email. In other illustrative embodiments, the user may specify individual recipients that are to be restricted from sending reply emails. Thus, one or more secondary recipients may be restricted from sending replies to the original email while other secondary recipients may be permitted to send replies to the original email. In other illustrative embodiments, the user may even specify primary recipients that are to be restricted from sending replies to the original email, if desired.

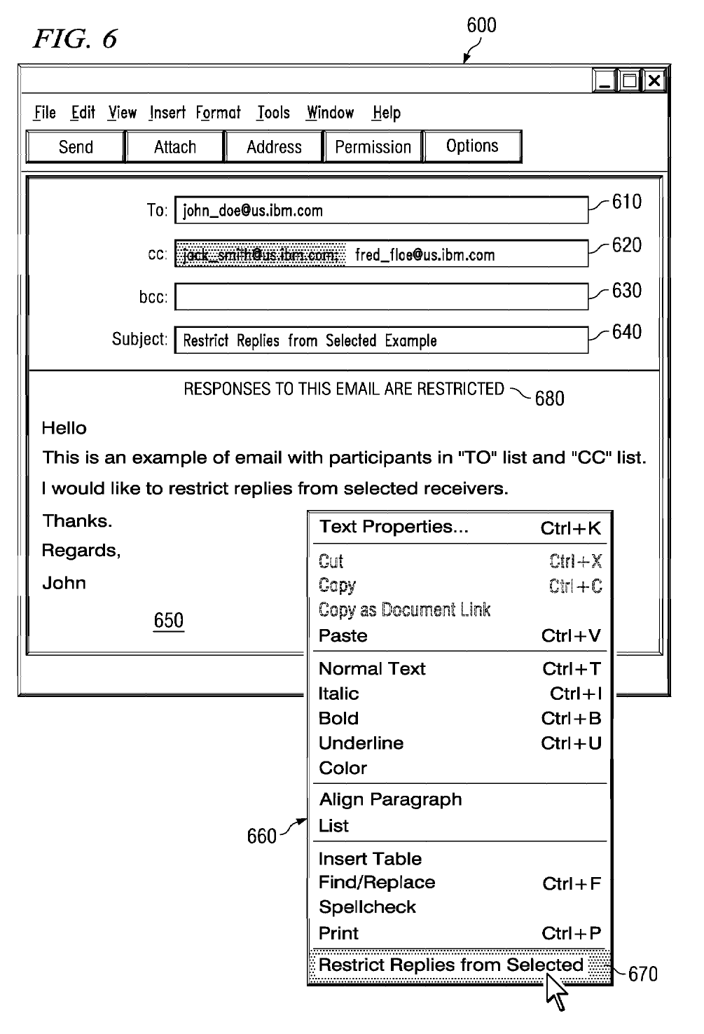

FIG. 6 is an exemplary diagram illustrating a user interface of an electronic mail client application in which individual recipients may be specified as recipients from which responses or replies may not be received in accordance with one illustrative embodiment. As shown in FIG. 6, similar to the illustrative embodiment described with regard to FIG. 4 above, a user may enter various email addresses of primary and secondary recipients of the email in fields 610-630 as well as a subject description in field 640. Body text of the email may be entered in field 650.

The user may select one or more individual email addresses in one or more of the fields 610-630 using a user input device, such as a mouse, keyboard, or the like, and may enter a command for the user interface to provide pop-up menu 660. For example, the user may “right-click” a computer mouse to cause the pop-up menu 660 to be displayed. While a pop-up menu 660 is depicted in this example, it should be appreciated that the present invention is not limited to such and any of a number of different user interface elements may be used to provide the command options in pop-up menu 660 without departing from the spirit and scope of the present invention.

From the pop-up menu 660, the user may select an option 670 to restrict replies from the selected email addresses in fields 610-630. In response to the user selection of one or more email addresses in fields 610-630 and the user selection of the “restrict replies from selected” command option 670, a restricted recipient reply indicator may be added to the code/data representing the email which designates which email addresses are restricted from providing replies to the email. In this way, when the email is received at a client email application, the client email application may process the restricted recipient reply indicator and compare the email address associated with the client email application to the listing of email addresses from which replies are restricted. If the email address associated with the client email application matches an email address in the listing of restricted reply email addresses, then appropriate reply restriction actions may be performed by the client email application, e.g., graying out reply command elements of the user interface, displaying a warning message, or the like.

Thus, in addition to being able to restrict replies from all secondary recipients of an email, the mechanisms of the illustrative embodiments allow a user to specify individual recipients of the email as being restricted from sending replies. While the depicted example requires that the user select individual email addresses from the fields 610-630 of the email user interface and then selecting a “restrict replies from selected” command option, it should be appreciated that the present invention is not limited to such. Rather, in an alternative embodiment, a field similar to fields 610-630 may be added to the user interface for specifying email addresses to which a copy of the email is to be sent but from which replies are restricted. Thus, similar to the “CC” field 620, a field denoted “CCRR” (carbon copy replies restricted) may be provided into which a user may enter email addresses of recipients to which copies of the email are to be provided but from which replies are to be restricted. Other implementations of the mechanisms of the illustrative embodiments for restricting replies from certain recipients of an original email may be used without departing from the spirit and scope of the present invention.

As discussed above, rather than performing the reply restriction operations entirely at the recipient client email application, some or all of the reply restriction operations may be performed at the computing device of the originator of the email using filter lists generated during the composing of the original email. For example, when a user selects individual recipients of the email from the fields 610-630 and selects the “restrict replies from selected” option 670, a listing keyed to an identifier of the email may be generated that lists those email addresses selected as being reply restricted email addresses. This listing may then be applied to all replies to the original email received by the email application on the originator's computing device to determine which replies should be presented to a user and which should be automatically discarded or placed in a trash or junk email folder of the email application.

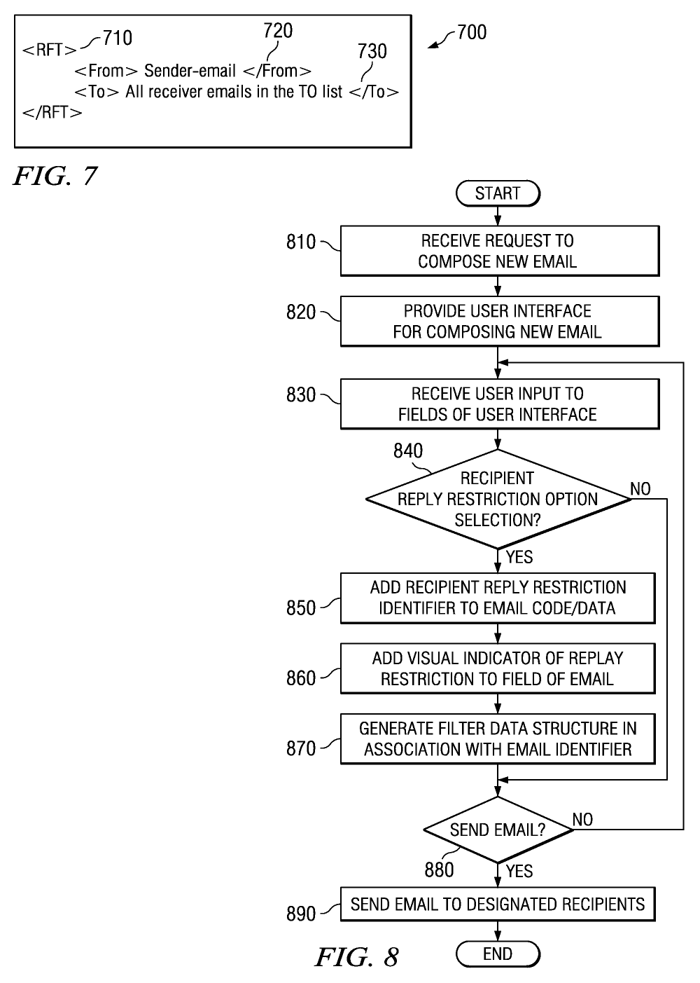

As described above, in some illustrative embodiments, the selection of a “replies from TO only” option or a “restrict replies from selected” option causes an identifier to be added to the code/data representing the email message. FIG. 7 is an exemplary diagram illustrating a recipient reply restriction identifier of an electronic mail message in accordance with one illustrative embodiment. As shown in FIG. 7, in the depicted example the reply restriction identifier is provided as a HyperText Markup Language (HTML) tag that is added to the HTML code representing the email message. Although an HTML tag implementation is shown in FIG. 7, the illustrative embodiments are not limited to using HTML tags and may use other types of indicators, including other types of markup languages for example, without departing from the spirit and scope of the present invention.

As shown in FIG. 7, the HTML tag 700 includes a “response from to” (RFT) tag 710, a “from” tag 720 specifying an email address from which the original email was sent, and a “to” tag 730 specifying a listing of email addresses that are in the “TO” field of the email. It should be appreciated that in other exemplary implementations of the present invention, the email addresses that are to be restricted from replying to the original email may be specified in this HTML tag 700 in addition to, or in replacement of, the “to” tag 730.

During processing of this HTML tag 700, in accordance with one illustrative embodiment, a client email application may first determine if the code/data of the email has this HTML tag 700 and if so, performs a series of checks on outgoing emails from the client email application. First, the client email application checks to determine if an outgoing email is a reply or forwarding to the original sender of the original email. This check may be performed, for example, using the “from” tag 720 in the HTML tag 700 to see if a “TO” field of the reply or forwarding email matches the email address in the “from” tag 720.

If the reply or forwarding email is being sent to the email address in the “from” tag 720, a check is made to determine if the client email application is associated with an email address that is listed in the “to” tag 730 of the HTML tag 700. If so, then the reply or forwarding email is permitted to be sent without restriction. If the email address of the client email application is not in the “to” tag 730, then the reply or forwarding email is restricted in one or more of the ways previously described above, e.g., displaying a warning message, disabling the reply option user interface elements, or the like. If the reply or forwarding email is not being sent to the original sender of the original email, or there is no RFT tag 710 associated with the original email, then the reply or forwarding email is permitted to be sent without restriction.

As described above, the original HTML tag 700 is carried in the code/data representing the original email for the life of the email. Thus, even if the email is forwarded to other email addresses that are not in the “TO” field of the original email, those email addresses will also not be able to send a reply/forward to the original sender of the original email. Thus, the mechanisms of the illustrative embodiments provide the ability to restrict replies/forwards of emails by those recipients selected by the originator of an email. Such restriction may be performed with regard to individual recipients of the original email, groups of recipients of the original email, e.g., secondary recipients, or the like.

FIGS. 8-10 are flowcharts outlining exemplary operations of client electronic mail applications in accordance with one or more illustrative embodiments. It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

FIG. 8 is a flowchart outlining an exemplary operation of an electronic mail client application when generating an electronic mail message for transmission in accordance with one illustrative embodiment. As shown in FIG. 8, an operation for generating an original electronic mail message may start with an email client application receiving a request to compose a new email message (step 810). Thereafter, a user interface for composing an email message is presented by the email client application (step 820). The client email application may receive user input, via the user interface, specifying zero or more primary recipients, zero or more secondary recipients, a subject, and a body of text for the email message (step 830). If no primary recipients are specified, then at least one secondary recipient should be specified. If at least one primary recipient is specified, then zero or more secondary recipients may be specified.

A determination may be made as to whether a user input selecting a recipient reply restriction command option is received (step 840). If a recipient reply restriction command option is selected by the user, a recipient reply restriction identifier is added to the code/data representing the email (step 850). A visual indicator of the reply restriction may optionally be added to a field of the email message as well (step 860). Moreover, a filter data structure may optionally be generated based on the selected recipient reply restriction command option that was selected by the user (step 870). This filter data structure may be stored in association with an identifier of the email for later use in filtering replies or forwarded emails corresponding to the original email.

Thereafter, or if the user does not select a recipient reply restriction command option, a determination is made as to whether the user selects a send command via the user interface (step 880). If the user does not select a send command, the operation returns to step 830 where additional input from the user may be received. If the user does select a send command, the email message is sent to the recipients specified in the appropriate fields of the email message (step 890). The sending of the email message includes sending the recipient reply restriction identifier since the identifier is embedded in the code/data that represents the email message. The operation then terminates.

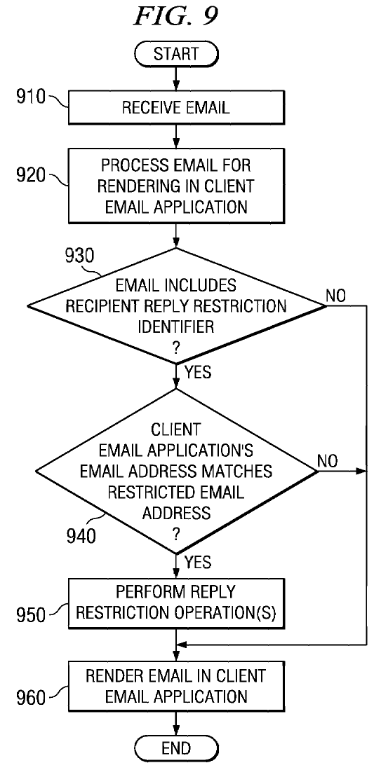

FIG. 9 is a flowchart outlining an exemplary operation of an electronic mail client application when receiving an electronic mail message in accordance with one illustrative embodiment. With regard to FIG. 9, an operation for receiving an email message in a recipient computing device begins with a client email application running on the recipient computing device receiving the email message (step 910). The email message is processed in order to render the email via the client email application (step 920). As part of this processing, a determination is made as to whether the email includes a recipient reply restriction identifier (step 930). If the email message does not contain a recipient reply restriction identifier, the email message is rendered (step 960) and the operation terminates.

If the email message includes a recipient reply restriction identifier, a determination may be made as to whether the client email application has an associated email address that matches an email address for which replies are restricted (step 940). Alternatively, the determination may be whether or not the email address associated with the client email application is one from which replies are permitted, e.g., matches an email address in the “TO” field of the received email message.

If the email address of the client email application matches a restricted reply recipient's email address, then various reply restriction operations may be performed by the client email application (step 950). For example, reply command options in the user interface of the client email application may be disabled when rendering the email message via the client email application. In addition, the client email application may output a message informing a user of the recipient computing device that replies to the rendered email message are restricted. The reply restriction operations performed by the client email application are operations designed to restrict the ability of the user of the recipient computing device to reply to the original email message.

The email message is rendered via the client email application (step 960). As mentioned above, if the reply restriction operations include disabling the reply command options in the user interface of the client email application, then these options may be removed or grayed out in the user interface when rendering the email message. Moreover, if the reply restriction operations include outputting a warning message that replies are restricted, then this warning message may be output when rendering the email message or in response to a user attempting to select a reply command option via the user interface of the client email application. After rendering the email message, the operation terminates.

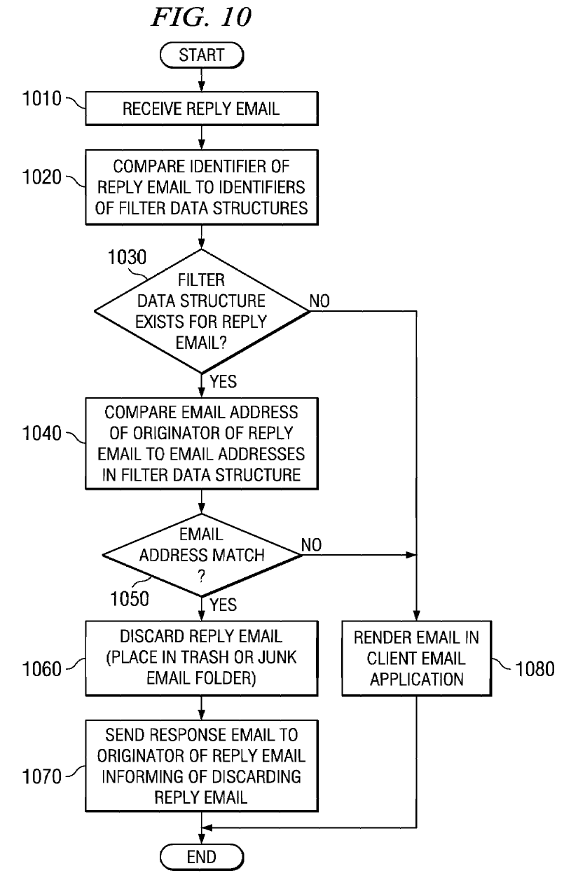

FIG. 10 is a flowchart outlining an exemplary operation of a client email application when receiving a reply to an original email in accordance with one illustrative embodiment. As shown in FIG. 10, the operation starts with the client email application receiving a reply email message (step 1010). An identifier of the email message is compared against one or more filter data structures stored in a manner where the filter data structures are keyed to email message identifiers (step 1020). A determination is made as to whether a filter data structure exists for the received reply email message (step 1030). If not, the reply email message is rendered on the client email application (step 1080) and the operation terminates.

If a filter data structure exists for the received reply email message, an email address corresponding to the originator of the reply email message is compared to the email addresses specified in the filter data structure (step 1040). A determination is made as to whether there is a match between the email address of the originator of the reply email message and one or more email addresses in the filter data structure (step 1050). If there is a match, the reply email message is discarded, e.g., placed in a trash or junk email folder, and is not rendered by the client email application (step 1060). A response email may be returned to the originator of the reply email message to inform them that their reply email is being ignored (step 1070). If there is not a match, then the reply email message is rendered on the client email application (step 1080) and the operation terminates.

The above exemplary mechanism assumes that the filter data structure for the original email message specifies those recipients of the original email that are not permitted to respond to the original email. In some instances, it may be more beneficial to specify in the filter data structure those recipients that are permitted to respond to the original email message. Thus, if the email address of the originator of a reply email message is not listed as one of the recipients from which replies are permitted, the reply email message may be discarded as described above. In this way, if the original email message is forwarded to other recipients not listed in the original email distribution, replies from these other recipients would not be permitted since they are not listed in the filter data structure associated with the original email message as recipients from which replies are permitted.

Thus, the mechanisms of the illustrative embodiments provide an ability to restrict replies from recipients of an electronic mail message. Such restriction helps to limit the number of replies a creator of an email message receives such that only those recipients that the creator wishes to receive replies from can actually reply to the original email. In this way, the creator of the email message is not subjected to unwanted email interaction with recipients that were copied on the email message for courtesy or informative reasons.

It should be appreciated that the illustrative embodiments may take the form of an entirely hardware embodiment, an entirely software embodiment or an embodiment containing both hardware and software elements. In one exemplary embodiment, the mechanisms of the illustrative embodiments are implemented in software, which includes but is not limited to firmware, resident software, microcode, etc.

Furthermore, the illustrative embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for specifying recipients of an original electronic mail (email) message that may respond to the original email message, comprising:
providing a user interface through which the original email message may be composed;
receiving a first user input to the user interface specifying one or more email addresses of one or more recipients of the original email message and a content of the original email message;
receiving a second user input selecting a response restriction option to prevent response email messages to the original email message from at least one of the one or more email addresses of the one or more recipients;
adding an indicator of the selected response restriction option to a data structure associated with the original email message; and
transmitting the original email message to one or more computing devices associated with the one or more email addresses of the one or more recipients.

2. The method of claim 1, wherein receiving a second user input comprises:
receiving a selection of one or more individual email addresses of one or more recipients of the original email message whose responses to the original email message are to be restricted.

3. The method of claim 1, wherein receiving a second user input comprises:
receiving a selection of a restriction option that specifies that email addresses of all secondary recipients of the original email message are restricted from sending response email messages while email addresses associated with primary recipients of the original email message are permitted to send response email messages.

4. The method of claim 3, wherein the primary recipients are recipients whose email address is specified by the first user input in a “TO” field of the user interface, and wherein the secondary recipients are recipients whose email address is specified by the first user input in either a carbon copy field or a blind carbon copy field of the user interface.

5. The method of claim 1, wherein adding an indicator of the selected response restriction option to a data structure associated with the original email message comprises:
adding the indicator to data representing the original email message, wherein the indicator specifies one of the one or more email addresses of the one or more recipients of the original email message that may send response email messages or one or more email addresses of the one or more recipients of the original email message that may not send response email messages.

6. The method of claim 5, wherein the indicator is a markup language tag having corresponding attributes, added to code of the original email message.

7. The method of claim 5, further comprising:
processing the indicator along with remaining data representing the original email message at a recipient computing device associated with a recipient whose email address is specified by the first user input;
determining if the recipient is to be prevented from sending a response to the original email message, wherein the determination is based on the indicator; and
modifying an email user interface on the recipient's computing device to prevent a response email message to the original email message from being composed if it is determined that the recipient is to be prevented from sending a response to the original email message.

8. The method of claim 7, wherein modifying the email user interface on the recipient's computing device comprises making an option to respond to the original email message unselectable by a user of the recipient's computing device.

9. The method of claim 1, further comprising:
inserting, in response to receiving the second user input, a visual indicator in a representation of the original email message indicating that responses to the original email message are restricted.

10. The method of claim 1, wherein adding an indicator of the selected response restriction option to a data structure associated with the original email message comprises:
generating a filter data structure, the filter data structure specifying one of one or more email addresses of the one or more recipients that may send response email messages to the original email message or one or more email addresses of the one or more recipients that may not send response email messages to the original email message; and
storing the filter data structure on the data processing system in association with an identifier of the original email message.

11. The method of claim 10, further comprising:
receiving a response email message to the original email message;
comparing an email address of an originator of the response email message to one or more email addresses specified in the filter data structure to thereby determine if the response email message is to be output on the data processing system; and
blocking an output of the response email message on the data processing system if a result of the determination is that the response email message is not to be output on the data processing system.

12. The method of claim 11, wherein blocking the output of the response email message on the data processing system comprises one of automatically deleting the response email message or automatically placing the response email message in a specified data structure associated with an email application running on the data processing system.

13. The method of claim 11, further comprising:
automatically sending, in response to blocking the output of the response email message on the data processing system, a reply email message to the originator of the response email message, the reply email message having content indicating that the response email message has been ignored.

14. A computer program product comprising a computer useable medium having a computer readable program, wherein the computer readable program, when executed on a computing device, causes the computing device to:
provide a user interface through which the original email message may be composed;
receive a first user input to the user interface specifying one or more email addresses of one or more recipients of the original email message and a content of the original email message;
receive a second user input selecting a response restriction option to prevent response email messages to the original email message from at least one of the one or more email addresses of the one or more recipients;
add an indicator of the selected response restriction option to a data structure associated with the original email message; and
transmit the original email message to one or more computing devices associated with the one or more email addresses of the one or more recipients.

15. The computer program product of claim 14, wherein the second user input is one of a selection of one or more individual email addresses of the one or more recipients of the original email message whose responses to the original email message are to be restricted or a selection of a restriction option that specifies that email addresses of all secondary recipients of the original email message are restricted from sending response email messages while email addresses associated with primary recipients of the original email message are permitted to send response email messages.

16. The computer program product of claim 14, wherein the computer readable program causes the computing device to add an indicator of the selected response restriction option to a data structure associated with the original email message by:
adding the indicator to data representing the original email message, wherein the indicator specifies one of one or more email addresses of the one or more recipients of the original email message that may send response email messages or one or more email addresses of the one or more recipients of the original email message that may not send response email messages.

17. The computer program product of claim 14, wherein the computer readable program further causes the computing device to:
insert, in response to receiving the second user input, a visual indicator in a representation of the original email message indicating that responses to the original email message are restricted.

18. The computer program product of claim 14, wherein the computer readable program causes the computing device to add an indicator of the selected response restriction option to a data structure associated with the original email message by:
generating a filter data structure, the filter data structure specifying one of one or more email addresses of the one or more recipients that may send response email messages to the original email message or one or more email addresses of the one or more recipients that may not send response email messages to the original email message; and
storing the filter data structure on the data processing system in association with an identifier of the original email message.

19. The computer program product of claim 18, wherein the computer readable program further causes the computing device to:
receive a response email message to the original email message;
compare an email address of an originator of the response email message to one or more email addresses specified in the filter data structure to thereby determine if the response email message is to be output on the data processing system; and
block an output of the response email message on the data processing system if a result of the determination is that the response email message is not to be output on the data processing system.

20. A system, comprising:
a processor; and
a memory coupled to the processor, the memory comprising instructions which, when executed by the processor, cause the processor to:
provide a user interface through which the original email message may be composed;
receive a first user input to the user interface specifying one or more email addresses of one or more recipients of the original email message and a content of the original email message;
receive a second user input selecting a response restriction option to prevent response email messages to the original email message from at least one of the one or more email addresses of the one or more recipients;
add an indicator of the selected response restriction option to a data structure associated with the original email message; and
transmit the original email message to one or more computing devices associated with the one or more email addresses of the one or more recipients.
